(19) United States
(12) Patent Application Publication
(10) Pub. No.: US 2023/0139642 A1
(43) Pub. Date: May 4, 2023

(54) METHOD AND APPARATUS FOR EXTRACTING SKILL LABEL

(71) Applicant: BEIJING BAIDU NETCOM SCIENCE TECHNOLOGY CO., LTD., Beijing (CN)

(72) Inventors: Kaichun YAO, Beijing (CN); Hengshu ZHU, Beijing (CN); Peng WANG, Beijing (CN); Xin SONG, Beijing (CN); Jingshuai ZHANG, Beijing (CN); Chuan QIN, Beijing (CN); Jing WANG, Beijing (CN)

(21) Appl. No.: 18/089,792

(22) Filed: Dec. 28, 2022

(30) Foreign Application Priority Data
Jan. 19, 2022 (CN) 202210061251.5

(51) Int. Cl. G06F 40/289; G06F 40/35; G06F 40/205

(52) U.S. Cl. CPC G06F 40/289; G06F 40/35; G06F 40/205

(57) ABSTRACT

A method and an apparatus for extracting a skill label, and a method and an apparatus for training a candidate phrase classification model are provided. The method for extracting the skill label includes obtaining a plurality of words by performing word segmentation on a sentence to be extracted, and determining a multi-dimensional feature vector of each word; extracting a candidate phrase from the sentence to be extracted; determining a multi-dimensional feature vector of each word in the candidate phrase according to the multi-dimensional feature vector of each word; generating a semantic representation vector of the candidate phrase according to the multi-dimensional feature vector of each word in the candidate phrase; and extracting the skill label from the sentence to be extracted based on the semantic representation vector of the candidate phrase.

### CROSS-REFERENCE TO RELATED APPLICATION

This application claims priority to and benefits of Chinese Patent Application No. 202210061251.5, filed with the China National Intellectual Property Administration on Jan. 19, 2022, the entire content of which is incorporated herein by reference.

### FIELD

The present disclosure relates to a field of a data processing technology, in particularly to a field of artificial intelligence and deep learning technologies, and more particularly to a method for extracting a skill label, an apparatus for extracting a skill label, a method for training a candidate phrase classification model and an apparatus for training a candidate phrase classification model.

### BACKGROUND

In enterprise recruitment and personnel management scenarios, there are massive multi-source heterogeneous data including resumes, recruitment position descriptions, personnel evaluation data, and the like. Generally, personnel insight may be realized through labeling, which not only saves management costs for enterprises, but also is an important process for enterprises to realize intelligent personnel management.

In a related art, skill labels may be extracted from the multi-source heterogeneous data in a supervised or unsupervised manner, but an extraction accuracy needs to be improved.

### SUMMARY

The present disclosure provides a method for extracting a skill label, an apparatus for extracting a skill label, a method for training a candidate phrase classification model and an apparatus for training a candidate phrase classification model.

According to a first aspect of the present disclosure, a method for extracting a skill label is provided. The method includes obtaining a plurality of words by performing word segmentation on a sentence to be extracted, and determining a first multi-dimensional feature vector of each word; extracting a candidate phrase from the sentence to be extracted; determining a second multi-dimensional feature vector of each word in the candidate phrase according to the first multi-dimensional feature vector of each word; generating a first semantic representation vector of the candidate phrase according to the second multi-dimensional feature vector of each word in the candidate phrase; and extracting the skill label from the sentence to be extracted based on the first semantic representation vector of the candidate phrase.

According to a second aspect of the present disclosure, a method for training a candidate phrase classification model is provided. The method includes obtaining a labeled training set and an unlabeled data set, in which the labeled training set includes a first sentence sample and a skill label sample corresponding to the first sentence sample, and the unlabeled data set includes second sentence samples and candidate phrase samples corresponding to the second sentence samples; obtaining a trained candidate phrase classification model by training the candidate phrase classification model according to the first sentence sample and the skill label sample corresponding to the first sentence sample; predicting a classification probability of each candidate phrase sample in the unlabeled data set based on the trained candidate phrase classification model; updating the labeled training set and the unlabeled data set based on the classification probability; and training the trained candidate phrase classification model based on the labeled training set updated.

According to a third aspect of the present disclosure, an electronic device is provided. The electronic device includes at least one processor; and a memory communicatively connected to the at least one processor for storing instructions executable by the at least one processor. The at least one processor is configured to execute the instructions to perform the method for extracting the skill label according to the first aspect of the present disclosure, and/or the method for training the candidate phrase classification model according to the second aspect of the present disclosure.

It should be understood that the content described in this part is neither intended to identify key or significant features of the embodiments of the present disclosure, nor intended to limit the scope of the present disclosure. Other features of the present disclosure will be easily understood through the following description.

### BRIEF DESCRIPTION OF THE DRAWINGS

The accompanying drawings are intended to provide a better understanding of the solutions and do not constitute a limitation on the present disclosure, in which:

FIG. 1 is a flowchart illustrating a method for extracting a skill label according to an embodiment of the present disclosure;

FIG. 2 is a block diagram illustrating a candidate phrase classification model according to an embodiment of the present disclosure;

FIG. 3 is a flowchart illustrating a method for extracting a skill label according to an embodiment of the present disclosure;

FIG. 4 is a flowchart illustrating a method for extracting a skill label according to an embodiment of the present disclosure;

FIG. 5 is a block diagram illustrating a candidate phrase classification model according to an embodiment of the present disclosure;

FIG. 6 is a flowchart illustrating a method for extracting a skill label according to an embodiment of the present disclosure;

FIG. 7 is a block diagram illustrating a candidate phrase classification model according to an embodiment of the present disclosure;

FIG. 8 is a flowchart illustrating a method for training a candidate phrase classification model according to an embodiment of the present disclosure;

FIG. 9 is a flowchart illustrating a method for training a candidate phrase classification model according to an embodiment of the present disclosure;

FIG. 10 is a flowchart illustrating a method for training a candidate phrase classification model according to an embodiment of the present disclosure;

FIG. 11 is a flowchart illustrating a method for training a candidate phrase classification model according to an embodiment of the present disclosure;

FIG. 12 is a block diagram illustrating an apparatus for extracting a skill label according to an embodiment of the present disclosure;

FIG. 13 is a block diagram illustrating an apparatus for training a candidate phrase classification model according to an embodiment of the present disclosure;

FIG. 14 is a block diagram illustrating an electronic device according to an embodiment of the present disclosure.

### DETAILED DESCRIPTION

Exemplary embodiments of the present disclosure are illustrated below with reference to the accompanying drawings, which include various details of the present disclosure to facilitate the understanding and should be considered to be only exemplary. Therefore, those skilled in the art should be aware that various changes and modifications can be made to the embodiments described herein without departing from the scope and spirit of the present disclosure. Similarly, for clarity and simplicity, descriptions of well-known functions and structures are omitted in the following description.

It is noted that the acquisition, storage and application of the user's personal information involved in the technical solution of the present disclosure comply with the provisions of relevant laws and regulations, and do not violate public order and customs. The personal information involved is acquired, stored and applied with the consent of the user.

In enterprise recruitment and personnel management scenarios, there are generally massive multi-source heterogeneous data including resumes, recruitment position descriptions, personnel evaluation data, and the like. In order to facilitate personnel management, personnel insight may be realized through labeling, which not only saves management costs for enterprises, but also is an important process for enterprises to realize intelligent personnel management.

In a related art, skill labels may be extracted from the multi-source heterogeneous data in a supervised or unsupervised manner, but an extraction accuracy needs to be improved. Based on the above-mentioned problems, a method for extracting a skill label, an apparatus for extracting a skill label, a method for training a candidate phrase classification model and an apparatus for training a candidate phrase classification model are provided.

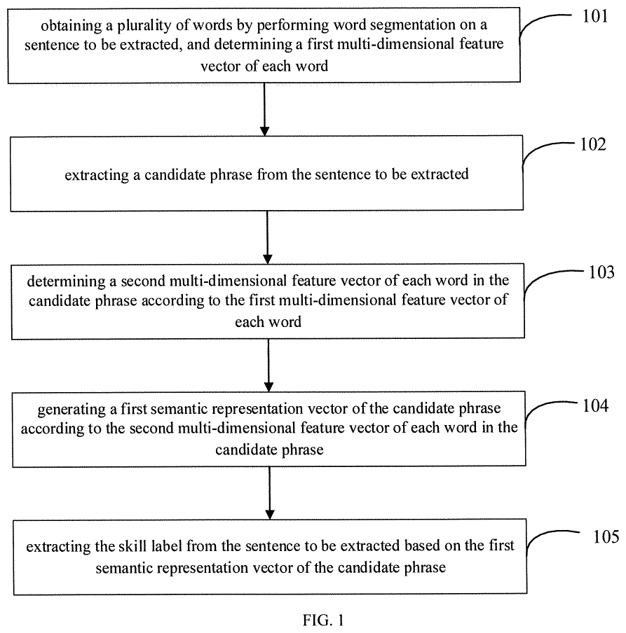

FIG. 1 is a flowchart illustrating a method for extracting a skill label according to an embodiment of the present disclosure. It is noted that the method for extracting the skill label in embodiments of the present disclosure may be used for the apparatus for extracting the skill label in embodiments of the present disclosure, and the apparatus for extracting the skill label in embodiments of the present disclosure may be configured in an electronic device. As shown in FIG. 1, the method for extracting the skill label may include the following steps 101 to 105.

In step 101, a plurality of words are obtained by performing word segmentation on a sentence to be extracted, and a first multi-dimensional feature vector of each word is determined.

In some embodiments of the present disclosure, the sentence to be extracted may be sentences in resumes, sentences in recruitment position descriptions, sentences in personnel evaluation data, or sentences in other data containing skill descriptions. In some embodiments, the sentence to be extracted may be obtained by acquiring a document selected by a user or a document uploaded by a user based on an interactive interface of the electronic device, automatically reading sentences in the document sentence by sentence based on a preset procedure, and determining each sentence read as the sentence to be extracted. In other embodiments, based on the interactive interface of the electronic device, the user may input the sentence from which a skill label needs to be extracted through the interactive interface, so that the corresponding sentence to be extracted may be obtained according to the information submitted by the interactive interface.

In some embodiments of the present disclosure, the word segmentation may be performed on the sentence to be extracted by using a word segmentation tool in a related art, or by using a word segmentation processing model constructed by those skilled in the art, which is not limited in the present disclosure.

The first multi-dimensional feature vector of each word refers to a vector representing semantics, part-of-speech and other features of each word. For example, the first multi-dimensional feature vector of each word may be based on a sequence composed of semantic features, part-of-speech features and dependency parsing features of the word. As an example, the semantic features of each word may be obtained by using word vector models such as word2Vec. The part-of-speech features of each word may be obtained by using part-of-speech labeling models in the related art. The dependency parsing features of each word may be obtained by using dependency parsing tools in the related art.

In step 102, a candidate phrase is extracted from the sentence to be extracted.

In some embodiments of the present disclosure, the candidate phrase refers to a combination of words that may be skill labels.

In some embodiments, the implementation process of extracting the candidate phrase from the sentence to be extracted may include extracting combinations of words in turn according to a preset window size and an order of the words in a word segmentation processing result of the sentence to be extracted, and determining each combination of the words as the candidate phrase. For example, if a plurality of words {x₁, x₂, x₃, x₄, x₅, x₆} are obtained by performing word segmentation on the sentence to be extracted, and the preset window size is 2, then the extracted candidate phrases are {x₁, x₂}, {x₂, x₃}, {x₃, x₄}, {x₄, x₅} and {x₅, x₆}.

In some embodiments, since the skill label is generally a combination of phrases with a certain part-of-speech, a candidate phrase template may be preset. The candidate phrase template may be obtained based on a large amount of data, including a plurality of combinations of part-of-speeches. That is, if several consecutive words in the word segmentation result are consistent with a combination of a certain the part-of-speech of words in the candidate phrase template, the consecutive words may be used as the candidate phrase.

In step 103, a second multi-dimensional feature vector of each word in the candidate phrase is determined according to the first multi-dimensional feature vector of each word.

It is understood that since the candidate phrase may include at least one word, the second multi-dimensional feature vector of each word in the candidate phrase may be determined according to the first multi-dimensional feature vector of each word.

In some embodiments of the present disclosure, the implementation process of this step may include determining at least one target word included in the candidate phrase, and determining a target multi-dimensional feature vector of each target word according to the first multi-dimensional feature vector of each word. That is, the target word contained in the candidate phrase may be first determined, and the target multi-dimensional feature vector of the target word may be found from the first multi-dimensional feature vector of each word.

In step 104, a first semantic representation vector of the candidate phrase is generated according to the second multi-dimensional feature vector of each word in the candidate phrase.

That is, features of the candidate phrase are characterized based on the second multi-dimensional feature vector of each word in the candidate phrase to obtain the first semantic representation vector of the candidate phrase.

In some embodiments, the second multi-dimensional feature vector of each word in the candidate phrase may be input into a model that may realize sequential semantic representation, so as to extract the features of the feature vectors combined and generate the first semantic representation vector of the candidate phrase.

In step 105, the skill label is extracted from the sentence to be extracted based on the first semantic representation vector of the candidate phrase.

That is, based on the first semantic representation vector of the candidate phrase, it is determined whether the candidate phrase is the skill label to achieve automatic extraction of the skill label.

As an example, a classification probability of the candidate phrase may be obtained based on the first semantic representation vector of the candidate phrase, and the candidate phrase is determined as the skill label in response to the classification probability being greater than a preset threshold. The classification probability of the candidate phrase may be obtained through classification with a classifier function.

It is noted that, in some embodiments of the present disclosure, after extracting the skill label from the sentence to be extracted, the method may further include determining a classification of the skill label. In general, in personnel management scenarios, the skill labels may be divided into soft skill labels, hard skill labels, and project labels. Therefore, after extracting the skill label, it is required to determine the classification of the skill label. As an example, a classification determining model trained may be used to determine the classification of the skill label extracted. The classification determining model trained may be a Bert semantic model. For example, the skill label is masked and input into the Bert semantic model for classification.

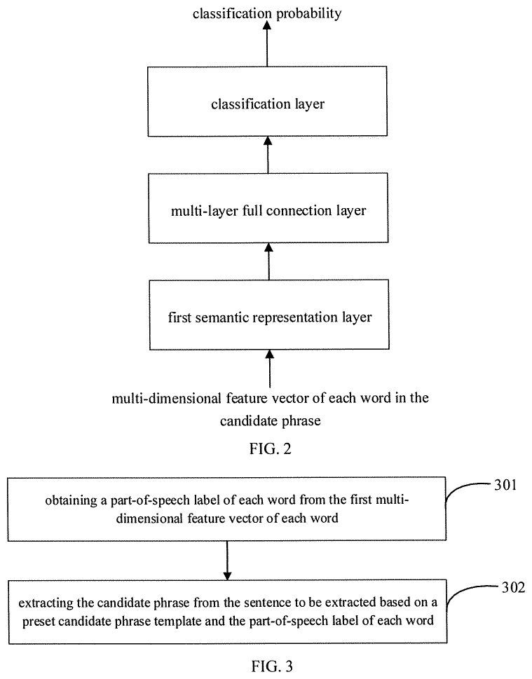

In addition, the method for extracting the skill label in embodiments of the present disclosure may be implemented based on a candidate phrase classification model. FIG. 2 is a schematic diagram illustrating a candidate phrase classification model in embodiments of the present disclosure. As shown in FIG. 2, the candidate phrase classification model includes a first semantic representation layer, a classification layer and a multi-layer full connection layer. The first semantic representation layer is configured to extract features from input vectors to implement sequential semantic representation, which may be a neural network for sequential semantic representation, such as a long-short term memory model. The multi-layer full connection layer is configured to transform the features from a high dimension to a low dimension. The classification layer is configured to perform classification based on the features, for example, using a sigmoid binary classification function.

It is noted that the candidate phrase classification model in embodiments of the present disclosure is a trained model, which may be obtained by performing training based on a labeled training set or by performing self-training based on a labeled training set and an unlabeled data set.

Based on the candidate phrase classification model shown in FIG. 2, the method for extracting the skill label in embodiments of the present disclosure may include obtaining a plurality of words by performing word segmentation on a sentence to be extracted, determining a first multi-dimensional feature vector of each word; extracting a candidate phrase from the sentence to be extracted; determining a second multi-dimensional feature vector of each word in the candidate phrase according to the first multi-dimensional feature vector of each word; generating a first semantic representation vector of the candidate phrase by inputting the second multi-dimensional feature vector of each word in the candidate phrase into the first semantic representation layer; obtaining a transformed feature vector by inputting the first semantic representation vector of the candidate phrase into the multi-layer full connection layer to perform feature transformation on the first semantic representation vector of the candidate phrase; obtaining a classification probability of the candidate phrase by inputting the transformed feature vector into the classification layer to perform classification based on the transformed feature vector; and determining the candidate phrase as the skill label in response to the classification probability being greater than a preset threshold.

According to the method for extracting the skill label in embodiments of the present disclosure, the candidate phrase is extracted from the sentence to be extracted, and the semantic representation vector of the candidate phrase is generated according to the multi-dimensional feature vector of each word in the candidate phrase, and the skill label is extracted from the sentence to be extracted based on the semantic representation vector of the candidate phrase, thus realizing the automatic extraction of the skill label. The multi-dimensional feature vector of each word in the candidate phrase is used to extract the skill label, which may effectively improve the accuracy of the extraction of the skill label, and provide useful conditions for enterprises to realize intelligent personnel management.

It is understood that the quality of the candidate phrase extracted may directly affect the calculation amount and accuracy of the extraction of the skill label. Therefore, in order to improve the efficiency and accuracy of the extraction of the skill label, the present disclosure also provides an embodiment as follows.

FIG. 3 is a flowchart illustrating a process for extracting the candidate phrase from the sentence to be extracted in embodiments of the present disclosure. As shown in FIG. 3, the implementation process of extracting the candidate phrase from the sentence to be extracted may include the following step 301 and step 302.

In step 301, a part-of-speech label of each word is obtained from the first multi-dimensional feature vector of each word.

It is understood that since the first multi-dimensional feature vector of each word contains the part-of-speech feature of each word, the part-of-speech feature of each word may be obtained from the first multi-dimensional feature vector of each word, and the part-of-speech label of each word may be determined according to the part-of-speech feature of each word. The part-of-speech label is a label that indicates words being verbs, nouns or the like.

As an example, the part-of-speech feature of each word may be obtained from the first multi-dimensional feature vector of each word, and the part-of-speech label of each word may be determined according to a mapping relationship between the part-of-speech features and the part-of-speech labels.

In step 302, the candidate phrase is extracted from the sentence to be extracted based on a preset candidate phrase template and the part-of-speech label of each word.

After studying the skill label, inventors of the present disclosure have found that the skill label is generally a combination of phrases with a certain part-of-speech, such as noun phrases. Therefore, the candidate phrase template may be configured in advance according to actual application scenarios. The candidate phrase template is a set that includes combinations of a variety of part-of-speeches, such as {noun, noun I +noun 2, verb +noun, . . . }. If the part-of-speech labels of consecutive words in the sentence to be extracted are consistent with a part-of-speech combination in the candidate phrase template, the corresponding phrase may be extracted as the candidate phrase. That is, by defining the candidate phrase template, the quality of the extracted candidate phrase may be effectively improved, that is, the possibility that the extracted candidate phrase are the skill label may be improved, which may avoid the waste of resources caused by low-quality candidate phrases, and also avoid the impact on the accuracy of the extraction of the skill label due to the failure to extract high-quality candidate phrases.

In embodiments of the present disclosure, the implementation process of step 302 may include comparing the part-of-speech labels of consecutive words in the sentence to be extracted with the part-of-speech combination in the candidate phrase template, and extracting a certain phrase as the candidate phrase if labels of words contained in the phrase in the sentence to be extracted are consistent with the part-of-speech combination in the candidate phrase template.

According to the method for extracting the skill label in embodiments of the present disclosure, based on the part-of-speech label of each word and the preset candidate phrase model, the candidate phrase is extracted from the sentence to be extracted to improve the quality of the extracted candidate phrase, that is, to improve the possibility that the extracted candidate phrase is the skill label, thus avoiding resource waste caused by low-quality candidate phrases, and avoiding the impact on the accuracy of extracting the skill label because high-quality candidate phrases are not extracted.

Since the semantic representation of the candidate phrase is generally related to a context of the candidate phrase, the present disclosure also provides an embodiment to further improve the accuracy of extracting the skill label.

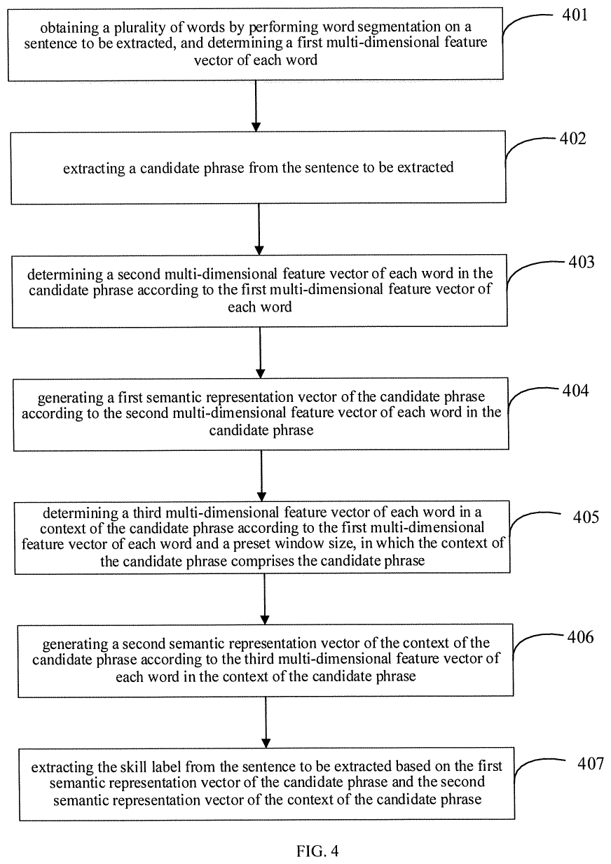

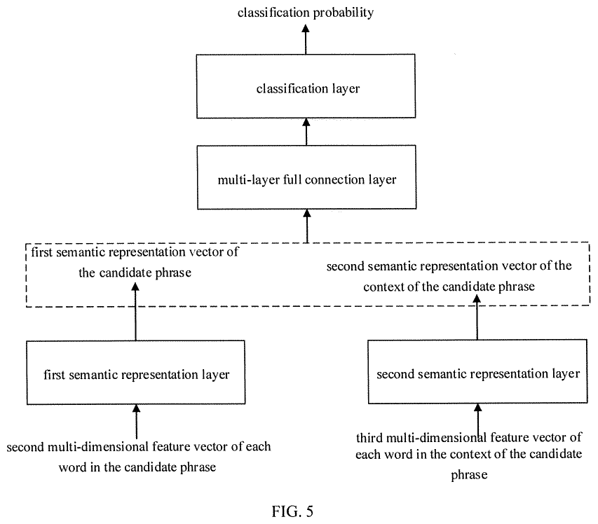

FIG. 4 is a flowchart illustrating a method for extracting a skill label according to an embodiment of the present disclosure. As shown in FIG. 4, the method includes the following step 401 to step 407.

In step 401, a plurality of words are obtained by performing word segmentation on a sentence to be extracted, and a first multi-dimensional feature vector of each word is determined.

In step 402, a candidate phrase is extracted from the sentence to be extracted.

In step 403, a second multi-dimensional feature vector of each word in the candidate phrase is determined according to the first multi-dimensional feature vector of each word.

In step 404, a first semantic representation vector of the candidate phrase is generated according to the second multi-dimensional feature vector of each word in the candidate phrase.

In step 405, a third multi-dimensional feature vector of each word in a context of the candidate phrase is determined according to the first multi-dimensional feature vector of each word and a preset window size. The context of the candidate phrase includes the candidate phrase.

As an example, if a plurality of words obtained after word segmentation processing on the sentence to be extracted are {x₁, x₂, x₃, x₄, x₅, x₆, x₇, x₈, x₉}, the candidate phrase is {x₄, x₅}, and the preset window size is 2, the context of the candidate phrase contains words {x₂, x₃, x₄, x₅, x₆, x₇}. That is, based on the respective multi-dimensional feature vectors of x₁, x₂, x₃, x₄, x₅, x₆, x₇, x₈ and x₉, the multi-dimensional feature vectors of x₂, x₃, x₄, x₅, x₆, and x₇ in the context of the candidate phrase are determined.

In step 406, a second semantic representation vector of the context of the candidate phrase is generated according to the third multi-dimensional feature vector of each word in the context of the candidate phrase.

It is understood that the context of the candidate phrase has an impact on semantic representation. Therefore, in order to improve the accuracy of extracting the skill label, the skill label may be generated by integrating the second semantic representation vector of the context of the candidate phrase with the first semantic representation vector of the candidate phrase.

In some embodiments, the third multi-dimensional feature vector of each word in the context of the candidate phrase may be input into a model that may realize the sequential semantic representation, so as to extract the features from the combined feature vectors and generate the second semantic representation vector of the context of the candidate phrase.

In step 407, the skill label is extracted from the sentence to be extracted based on the first semantic representation vector of the candidate phrase and the second semantic representation vector of the context of the candidate phrase.

As an example, a spliced feature vector is obtained by splicing the first semantic representation vector of the candidate phrase and the second semantic representation vector of the context of the candidate phrase. A classification probability of the candidate phrase is obtained according to the spliced feature vector. The candidate phrase is determined as the skill label in response to the classification probability being greater than a preset threshold. The classification probability of the candidate phrase may be obtained through classification with a classifier function.

It is noted that the method for extracting the skill label in embodiments of the present disclosure may be implemented based on a candidate phrase classification model. FIG. 5 is a schematic diagram illustrating a candidate phrase classification model according to an embodiment of the present disclosure. As shown in FIG. 5, the candidate phrase classification model may include a first semantic representation layer, a second semantic representation layer, a classification layer and a multi-layer connection layer. The first semantic representation layer is configured to perform extract features from the second multi-dimensional feature vector of each word in the candidate phrase to achieve the sequential semantic representation, which may be a neural network for the sequential semantic representation, such as a long-short term memory model. The second semantic representation layer is configured to extract features from the third multi-dimensional feature vector of each word in the context of the candidate phrase, which may also be a neural network for the sequential semantic representation, such as a long-short term memory model. The multi-layer full connection layer is configured to transform the features from a high dimension to a low dimension. The classification layer is configured to perform classification based on the features, for example, using a sigmoid binary classification function.

It is noted that the candidate phrase classification model in embodiments of the present disclosure is a trained model, which may be obtained by performing training based on a labeled training set or by performing self-training based on a labeled training set and an unlabeled data set.

Based on the candidate phrase classification model shown in FIG. 5, the implementation process of the method for extracting the skill label in the present disclosure may include obtaining a plurality of words by performing word segmentation on a sentence to be extracted, and determining a first multi-dimensional feature vector of each word; extracting a candidate phrase from the sentence to be extracted; determining a second multi-dimensional feature vector of each word in the candidate phrase according to the first multi-dimensional feature vector of each word; generating a first semantic representation vector of the candidate phrase by inputting the second multi-dimensional feature vector of each word in the candidate phrase into the first semantic representation layer; generating a second semantic representation vector of a context of the candidate phrase by inputting a third multi-dimensional feature vector of each word in the context of the candidate phrase into the second semantic representation layer; obtaining a spliced feature vector by splicing the first semantic representation vector of the candidate phrase and the second semantic representation vector of the context of the candidate phrase; obtaining a transformed feature vector by inputting the spliced feature vector into the multi-layer full connection layer to perform feature transformation on the spliced feature vector; obtaining a classification probability of the candidate phrase by inputting the transformed feature vector into the classification layer to perform classification based on the transformed feature vector; and determining the candidate phrase as the skill label in response to the classification probability being greater than a preset threshold.

According to the method for extracting the skill label in embodiments of the present disclosure, the multi-dimensional feature vector of each word in the context of the candidate phrase is added to generate the semantic representation vector of the context of the candidate phrase, and the skill label is extracted from the sentence to be extracted based on the semantic representation vector of the candidate phrase and the semantic representation vector of the context of the candidate phrase. That is, the semantic representation of the context of the candidate phrase context may be considered in the process of extracting the skill label, which may further improve the accuracy of the extraction of the skill label.

In order to improve the accuracy of the extraction of the skill label, the present disclosure also provides an embodiment as follows.

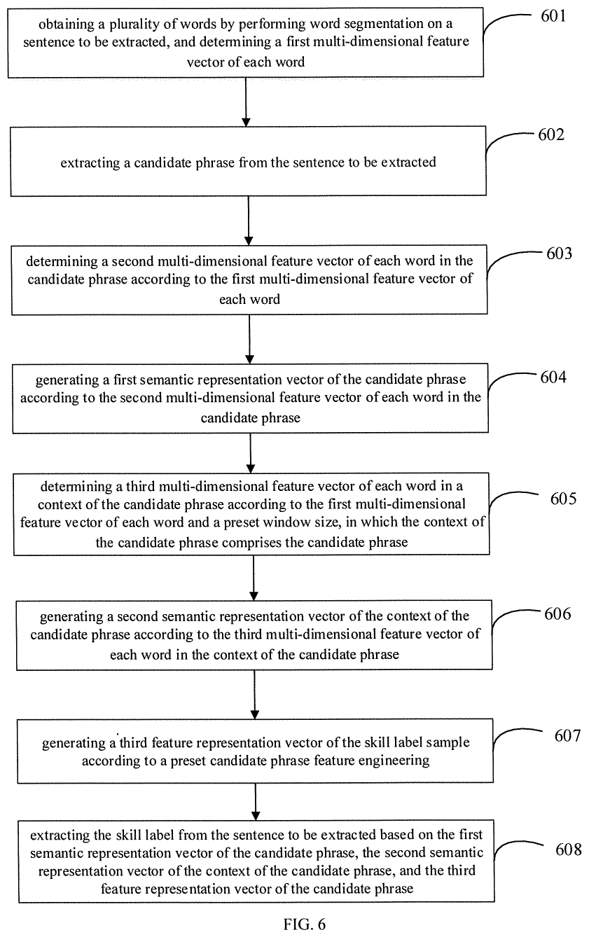

FIG. 6 is a flowchart illustrating a method for extracting a skill label according to an embodiment of the present disclosure. As shown in FIG. 6, an implementation process may include the following step 601 to step 608.

In step 601, a plurality of words are obtained by performing word segmentation on a sentence to be extracted, and a first multi-dimensional feature vector of each word is determined.

In step 602, a candidate phrase is extracted from the sentence to be extracted.

In step 603, a second multi-dimensional feature vector of each word in the candidate phrase is determined according to the first multi-dimensional feature vector of each word.

In step 604, a first semantic representation vector of the candidate phrase is generated according to the second multi-dimensional feature vector of each word in the candidate phrase.

In step 605, a third multi-dimensional feature vector of each word in a context of the candidate phrase is determined according to the first multi-dimensional feature vector of each word and a preset window size. The context of the candidate phrase includes the candidate phrase.

In step 606, a second semantic representation vector of the context of the candidate phrase is generated according to the third multi-dimensional feature vector of each word in the context of the candidate phrase.

In step 607, a third feature representation vector of the candidate phrase is generated according to a preset candidate phrase feature engineering.

In some embodiments of the present disclosure, the candidate phrase feature engineering is configured to extract other features of the candidate phrase from original data to improve the accuracy of the extraction of the skill label. As an example, the candidate phrase feature engineering may include features, such as the number of words in the candidate phrase, a position of the candidate phrase in the sentence to be extracted, and whether the candidate phrase is composed of English words.

In some embodiments, information of each feature in the candidate phrase feature engineering corresponding to the candidate phrase may be determined according to the candidate phrase feature engineering, so as to generate other feature representation vectors of the candidate phrase based on the expression of the information of the feature.

In step 608, the skill label is extracted from the sentence to be extracted based on the first semantic representation vector of the candidate phrase, the second semantic representation vector of the context of the candidate phrase, and the third feature representation vector of the candidate phrase.

As an example, the spliced feature vector may be obtained by splicing the semantic representation vector of the candidate phrase, the semantic representation vector of the context of the candidate phrase and other feature representation vectors of the candidate phrase. The classification probability of the candidate phrase is obtained according to the spliced feature vector.

In response to the classification probability being greater than the preset threshold, the candidate phrase is determined as the skill label. The classification probability of the candidate phrase may be obtained through classification with a classifier function.

It is noted that the method for extracting the skill label in embodiments of the present disclosure may also be implemented based on a candidate phrase classification model with a model structure consistent with the candidate phrase classification model in FIG. 5. The implementation process of the method for extracting the skill label may include obtaining a plurality of words by performing word segmentation on a sentence to be extracted, and determining a first multi-dimensional feature vector of each word; extracting a candidate phrase from the sentence to be extracted; determining a second multi-dimensional feature vector of each word in the candidate phrase according to the first multi-dimensional feature vector of each word; generating a first semantic representation vector of the candidate phrase by inputting the second multi-dimensional feature vector of each word in the candidate phrase into a first semantic representation layer; generating a second semantic representation vector in a context of the candidate phrase by inputting a third multi-dimensional feature vector of each word in the context of the candidate phrase into a second semantic representation layer; generating a third feature representation vector of the candidate phrase according to a preset candidate phrase feature engineering; obtaining a spliced feature vector by splicing the first semantic representation vector of the candidate phrase, the second semantic representation vector of the context of the candidate phrase and the third feature representation vector of the candidate phrase; obtaining a transformed feature vector by inputting the spliced feature vector into a multi-layer full connection layer to perform feature transformation on the spliced feature vector; obtaining a classification probability of the candidate phrase by inputting the transformed feature vector into a classification layer to perform classification based on the transformed feature vector; and determining the candidate phrase as the skill label in response to the classification probability being greater than a preset threshold.

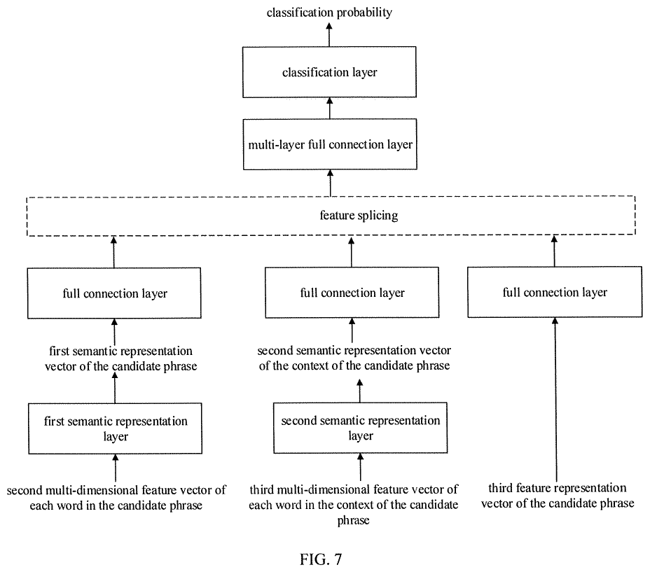

It is noted that since the semantic representation vector of the candidate phrase, the semantic representation vector of the context of the candidate phrase and other representation vectors of the candidate phrase may have high dimensions. Therefore, the semantic representation vector of the candidate phrase, the semantic representation vector of the context of the candidate phrase and other representation vectors of the candidate phrase may be respectively transformed through full connection layers to obtain the transformed feature vectors, and the transformed feature vectors are spliced. As an example, the structure of the candidate phrase classification model in embodiments of the present disclosure may also be as shown in FIG. 7. That is, outputs of the first semantic representation layer and the second semantic representation layer may be subjected to feature transformation through full connection layers, respectively, while other feature representation vectors of the candidate phrase may also be subjected to feature transformation through a full connection layer first, and then the transformed features are spliced and input into the multi-layer full connection layer.

According to the method for extracting the skill label in the embodiment of the present disclosure, a step of generating other feature representation vectors of the candidate phrase based on the candidate phrase feature engineering is added, and the skill label is extracted from the sentence to be extracted based on the semantic representation vector of the candidate phrase, the semantic representation vector of the context of the candidate phrase, and other feature representation vectors of the candidate phrase, which may make the feature expression of the candidate phrase more comprehensive, and further improve the accuracy of the extraction of the skill label.

In order to implement the above-mentioned embodiments, the present disclosure provides a method for training a candidate phrase classification model.

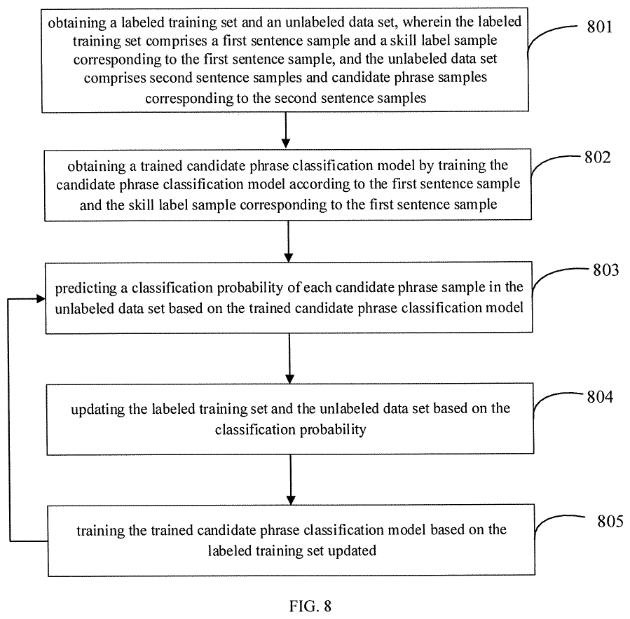

FIG. 8 is a flowchart illustrating a method for training a candidate phrase classification model according to an embodiment of the present disclosure. As shown in FIG. 8, the method includes the following step 801 to step 805.

In step 801, a labeled training set and an unlabeled data set are obtained. The labeled training set includes a first sentence sample and a skill label sample corresponding to the first sentence sample, and the unlabeled data set includes second sentence samples and candidate phrase samples corresponding to the second sentence samples.

In some embodiments of the present disclosure, the labeled training set is labeled data including the first sentence sample and the skill label sample corresponding to the first sentence sample. The skill label sample is a skill label labeled in the first sentence sample. The first sentence sample may be from a resume text, a recruitment position description text, personnel evaluation data or the like. Since there may be a plurality of skill label samples in each first sentence sample, in order to facilitate the use of the data, each skill label sample and the first sentence sample corresponding to the skill label sample in the labeled training set may be used as a group of sample data. For example, if the skill label samples corresponding to the first sentence sample s are a skill label sample L1, a skill label sample L2, and a skill label sample L3, the data form in the labeled training set is {first sentence sample s, skill label sample L1}, {first sentence sample s, skill label sample L2} and {first sentence sample s, skill label sample L3}.

In addition, the unlabeled data set refers to unlabeled data including the second sentence samples and the candidate phrase samples corresponding to the second sentence samples. The candidate phrase sample is a candidate phrase extracted from the first sentence sample. The second sentence sample may be from a resume text, a recruitment position description text, personnel evaluation data or the like. Moreover, a composition form of the samples in the unlabeled data set may be consistent with that in the labeled training set. That is, each candidate phrase sample and the second sentence sample corresponding to the candidate phrase sample are taken as a group of sample data. As an example, an implementation process of obtaining candidate phrase samples may include obtaining a plurality of words by performing word segmentation on the second sentence sample, and obtaining a part-of-speech label of each word through a part-of-speech labeling model; obtaining the candidate phrase sample corresponding to each second sentence sample by extracting the candidate phrase from the second sentence sample based on a preset candidate phrase template and the part-of-speech label of each word.

It is noted that due to the high cost of manual annotation, the number of samples in the unlabeled data set in embodiments of the present disclosure may be much greater than the number of samples in the labeled training set, so as to reduce the cost of obtaining training samples.

In step 802, a trained candidate phrase classification model is obtained by training the candidate phrase classification model according to the first sentence sample and the skill label sample corresponding to the first sentence sample.

In some embodiments of the present disclosure, the candidate phrase classification model is configured to classify candidate phrases to confirm whether the candidate phrases are the skill labels. The candidate phrase classification model may include a semantic representation layer and a classification layer. The feature information of the candidate phrase is input into the semantic representation layer of the candidate phrase classification model to extract the feature of the candidate phrase, the semantic representation vector of the candidate phrase is obtained, and the semantic representation vector is input into the classification layer for classification to output the classification probability of the candidate phrase.

As an example, the candidate phrase classification model may be trained by obtaining semantic features, part-of-speech features, and syntactic dependency word features of each word by performing word segmentation on the first sentence sample, determining feature information of each word in each skill label sample, obtaining a predicted classification probability by inputting the feature information of each word in each skill label sample into the candidate phrase classification model, calculating a loss value based on the predicted classification probability and a real classification value of the skill label sample, and training the candidate phrase classification model by adjusting the model parameters continuously based on the loss value.

In step 803, a classification probability of each candidate phrase sample in the unlabeled data set is predicted based on the trained candidate phrase classification model.

That is, the trained candidate phrase classification model has learned the sequential semantic representation ability and the classification ability based on the semantic representation result, which may predict the classification probability of the candidate phrase sample in the unlabeled data set based on the trained candidate phrase classification model.

In some embodiments, predicting the classification probability of the candidate phrase sample in the unlabeled data set may include obtaining a plurality of second words by performing word segmentation on a second sentence sample, and obtaining a multi-dimensional feature vector of each second word, in which the multi-dimensional feature vector includes semantic features, part-of-speech features, dependency parsing features and the like; determining a second target word contained in each candidate phrase sample, and determining the multi-dimensional feature vector of each second word in each candidate phrase sample based on the multi-dimensional feature vector of each second word in the second sentence sample; and predicting the classification probability of the candidate phrase sample in the unlabeled data set by inputting the multi-dimensional feature vector of each second word in the candidate phrase sample into the trained candidate phrase classification model.

It is noted that when this step is executed for a first time, the word segmentation is performed on the second sentence sample to obtain the multi-dimensional feature vector of each word in the second sentence sample so as to determine the multi-dimensional feature vector of each word in the candidate phrase sample. When the step is executed again in a loop, the multi-dimensional feature vector of each word in the second sentence sample obtained by performing the step for the first time may be directly used to determine the multi-dimensional feature vector of each word in the candidate phrase sample without performing word segmentation again and obtaining the multi-dimensional feature vector of each word again.

In addition, the trained candidate phrase classification model in step 803 refers to a candidate phrase classification model obtained after the latest training when the step is currently executed. The unlabeled data set refers to the latest unlabeled data set.

In step 804, the labeled training set and the unlabeled data set are updated based on the classification probability.

It is understood that since the small number of samples in an initial labeled training set, the trained candidate phrase classification model has limited prediction ability, and has a high prediction accuracy for more apparent candidate phrases (candidate phrases that may be easily identified as the skill labels). Therefore, based on the classification probability, some samples may be obtained from the unlabeled data set and used as labeled data to participate in the training of the model, which may gradually increase the number of samples in the labeled training set to achieve self-training of the model.

In some embodiments of the present disclosure, updating the labeled training set and the unlabeled data set based on the classification probability may include obtaining a target candidate phrase sample with a classification probability greater than a probability threshold from the candidate phrase samples; adding the target candidate phrase sample and a second sentence sample corresponding the target candidate phrase sample into the labeled training set, in which the target candidate phrase sample is a skill label sample of the second sentence sample corresponding to the target candidate phrase sample; deleting the target candidate phrase sample and the second sentence sample corresponding to the target candidate phrase sample in the unlabeled data set.

It is noted that the update operation on the labeled training set and the unlabeled data set is performed based on the latest labeled training set and the latest unlabeled data set when executing the step.

In step 805, the trained candidate phrase classification model is trained based on the labeled training set updated.

That is, based on the updated labeled training set, the candidate phrase classification model after training is trained, the classification probability of the candidate phrase sample in the updated unlabeled data set is predicted based on the obtained new trained candidate phrase classification model, and the labeled training set and the unlabeled data set are updated again based on the classification probability for looping.

It is understood that all sentence samples (including the first sentence sample and the second sentence sample added to the labeled training set) in the updated labeled training set are subjected to word segmentation, and the feature information of each word is obtained. Therefore, the feature information of the skill label sample (including the skill label sample corresponding to the first sentence sample, and the candidate label corresponding to the second sentence sample added to the labeled training set) may be directly input into the trained candidate phrase classification model to obtain the classification probability of the skill label sample, the loss value is calculated, and the model may be trained based on the loss value.

In embodiments of the present disclosure, after step 805 is executed, step 803 is executed to train the candidate classification model circularly until a preset condition is reached. For example, the number of cycles of training may be preset. If the number of cycles reaches a preset maximum, the training will be ended. Alternatively, if there is no transformation of the labeled training set and the unlabeled data set after updating, the training may be ended according to the updated situations of the labeled training set and the unlabeled data set.

According to the method for training the candidate phrase classification model in embodiments of the disclosure, the candidate phrase classification model is trained based on the labeled training set, and the labeled training set and the unlabeled data set are continuously updated based on the prediction result of the classification probability of the candidate phrase sample in the unlabeled data set with the trained candidate phrase classification model, so as to train the candidate phrase classification model circularly. That is, only a small amount of labeled data may be used to train the model, which may not only improve the training effect of the model based on self-training, but also reduce the cost of training data.

Next, based on the model structure of the candidate phrase classification model, the training process of the candidate phrase classification model will be introduced in detail.

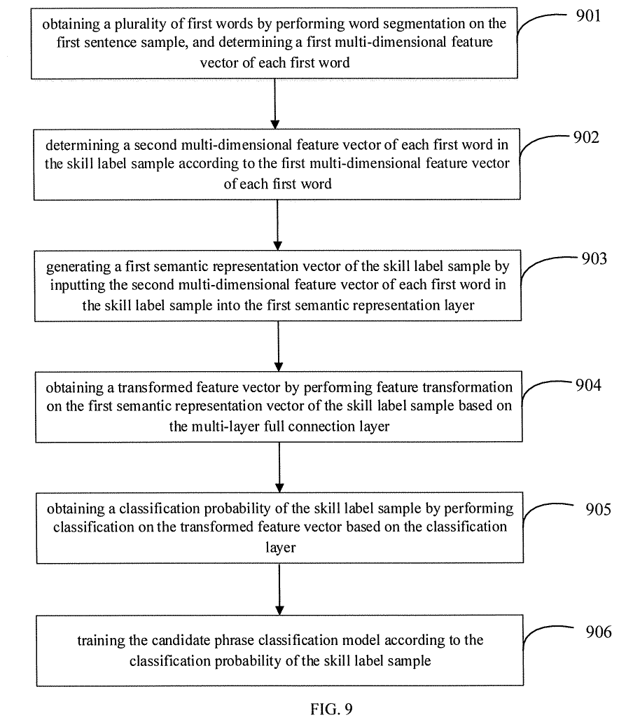

FIG. 9 is a flowchart illustrating a method for training a candidate phrase classification model according to an embodiment of the present disclosure. In embodiments of the present disclosure, the candidate phrase classification model includes a first semantic representation layer, a classification layer and a multi-layer full connection layer, which is consistent with the structure of the model shown in FIG. 2. Based on the above-mentioned embodiments, in step 802 in FIG. 8, obtaining the trained candidate phrase classification model by training the candidate phrase classification model according to the first sentence sample and the skill label sample corresponding to the first sentence sample may include the following step 901 to step 906 as shown in FIG. 9.

In step 901, a plurality of first words are obtained by performing word segmentation on the first sentence sample, and a first multi-dimensional feature vector of each first word is determined.

In some embodiments of the present disclosure, word segmentation may be performed on the first sentence sample by using a word segmentation tool in the related art, or by using a word segmentation model constructed by those skilled in the art, which is not limited in the present disclosure.

The first multi-dimensional feature vector of each first word refers to a vector that may represent the semantics, part-of-speech and other features of each first word. For example, the first multi-dimensional feature vector of each first word may be based on a sequence composed of the semantic features, part-of-speech features and dependency parsing features of the first word. As an example, the semantic features of each first word may be obtained by word vector models such as word2Vec. The part-of-speech features of each first word may be obtained by using the part-of-speech labeling model in related art. The dependency parsing features of each first word may be obtained by using the dependency parsing tools in related art.

In step 902, a second multi-dimensional feature vector of each first word in the skill label sample is determined according to the first multi-dimensional feature vector of each first word.

It is understood that since the skill label sample may include at least one first word, the multi-dimensional feature vector of each first word in the skill label sample may be determined according to the first multi-dimensional feature vector of each first word.

In some embodiments of the present disclosure, the implementation process of this step may include determining at least one first target word included in each skill label sample; and determining the multi-dimensional feature vector of each first target word according to the first multi-dimensional feature vector of each first word. That is, the first target word contained in the skill label sample may first determined, and then the multi-dimensional feature vector of the first target word is found from the first multi-dimensional feature vector of each first word.

In step 903, a first semantic representation vector of the skill label sample is generated by inputting the second multi-dimensional feature vector of each first word in the skill label sample into the first semantic representation layer.

In step 904, a transformed feature vector is obtained by performing feature transformation on the first semantic representation vector of the skill label sample based on the multi-layer full connection layer.

It is noted that the number of full connection layers may be determined according to the dimension of the feature vector, which is not limited in the disclosure.

In step 905, a classification probability of the skill label sample is obtained by performing classification on the transformed feature vector based on the classification layer.

In step 906, the candidate phrase classification model is trained according to the classification probability of the skill label sample.

In some embodiments of the present disclosure, training the candidate phrase classification model according to the classification probability of the skill label sample may include obtaining a real classification value of the skill label sample; obtaining a loss value according to the real classification value of the skill label sample and the classification probability of the skill label sample; and training the candidate phrase classification model according to the loss value.

It is noted that during the process of training the candidate phrase classification model shown in FIG. 2, the implementation process of step 805 in FIG. 8 may only include steps 903 to 905. That is, there is no need to perform word segmentation and obtain the multi-dimensional feature vector again.

It is noted that during the process of training the candidate phrase classification model shown in FIG. 2, the above-mentioned steps 901 to 905 may also be used in step 803 in FIG. 8. If step 803 is executed for a first time, the implementation process may include obtaining a plurality of second words by performing word segmentation on a second sentence sample in the unlabeled training set, and obtaining a first multi-dimensional feature vector of each second word; determining a second multi-dimensional feature vector of each second word in the candidate phrase sample in the unlabeled data set according to the first multi-dimensional feature vector of each second word; generating a semantic representation vector of the candidate phrase sample by inputting the second multi-dimensional feature vector of each second word in the candidate phrase sample into the first semantic representation layer of the candidate phrase classification model; obtaining a transformed feature vector by performing feature transformation on the semantic representation vector of the candidate phrase sample based on the multi-layer full connection layer; and predicting the classification probability of the candidate phrase samples by performing classification on the transformed feature vector based on the classification layer.

When step 803 is not executed for the first time, the implementation process may include generating the semantic representation vector of the candidate phrase sample by inputting the second multi-dimensional feature vector of each second word in the candidate phrase sample in the updated unlabeled data set into the first semantic representation layer of the candidate phrase classification model; obtaining a transformed feature vector by performing feature transformation on the semantic representation vector of the candidate phrase sample based on the multi-layer full connection layer; predicting the classification probability of the candidate phrase sample by performing classification on the transformed feature vector based on the classification layer.

According to the method for training the candidate phrase classification model in embodiments of the present disclosure, the candidate phrase classification model is trained based on the labeled training set, and the labeled training set and the unlabeled data set are continuously updated based on the prediction result of the classification probability of the candidate phrase sample in the unlabeled data set with the trained candidate phrase classification model, so as to train the candidate phrase classification model circularly. That is, only a small amount of labeled data may be used to train the model, which may improve the training effect of the model based on self-training, and reduce the cost of training data.

In order to further improve the training effect of the model, the present disclosure also provides an embodiment as follows.

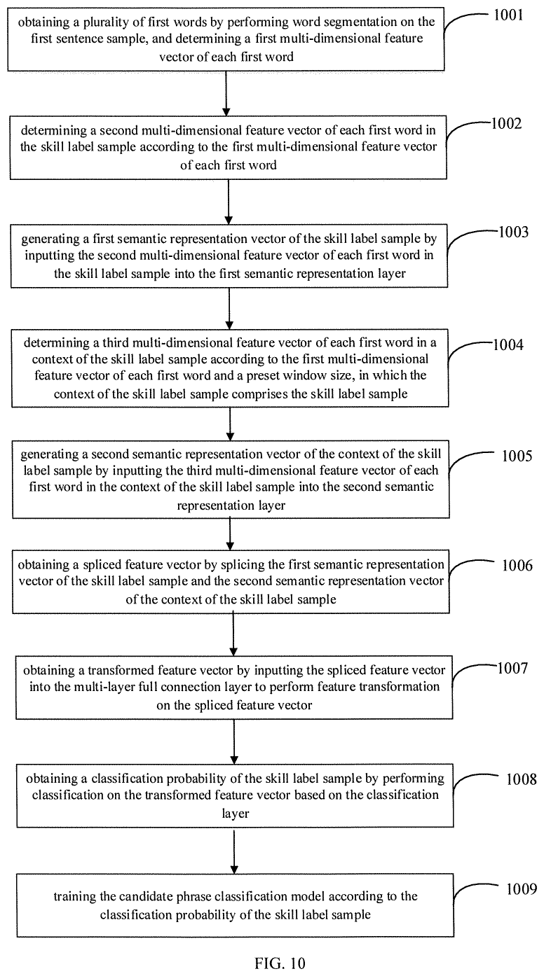

FIG. 10 is a flowchart illustrating the method for training a candidate phrase classification model according to an embodiment of the present disclosure. In embodiments of the present disclosure, the candidate phrase classification model includes a first semantic representation layer, a second semantic representation layer, a classification layer, and a multi-layer full connection layer, which has a structure consistent with that in the model shown in FIG. 5. Based on the above-mentioned embodiment, in step 802 in FIG. 8, the implementation process of obtaining the trained candidate phrase classification model by training the candidate phrase classification model according to the first sentence sample and the skill label sample corresponding to the first sentence sample may include step 1001 to step 1009 as shown in FIG. 10.

In step 1001, a plurality of first words are obtained by performing word segmentation on the first sentence sample, and a first multi-dimensional feature vector of each first word is determined.

In step 1002, a second multi-dimensional feature vector of each first word in the skill label sample is determined according to the first multi-dimensional feature vector of each first word.

In step 1003, a first semantic representation vector of the skill label sample is generated by inputting the second multi-dimensional feature vector of each first word in the skill label sample into the first semantic representation layer.

In step 1004, a third multi-dimensional feature vector of each first word in a context of the skill label sample is determined according to the first multi-dimensional feature vector of each first word and a preset window size. The context of the skill label sample includes the skill label sample.

Since the semantic representation of the skill label sample is generally also related to the context of the skill label sample, in order to further improve the training effect of the model, the multi-dimensional feature vector of each first word in the context of the skill label sample is obtained to obtain more comprehensive feature of the skill label sample.

In step 1005, a second semantic representation vector of the context of the skill label sample is generated by inputting the third multi-dimensional feature vector of each first word in the context of the skill label sample into the second semantic representation layer.

In step 1006, a spliced feature vector is obtained by splicing the first semantic representation vector of the skill label sample and the second semantic representation vector of the context of the skill label sample.

It is understood that the context of the skill label generally has an impact on the semantic representation. Therefore, in order to improve the training effect of the model, the semantic representation vector of the skill label sample and the semantic representation vector of the context of the skill label sample may be spliced.

In embodiments of the present disclosure, the feature splicing of the semantic representation vector of the skill label sample and the semantic representation vector of the context of the skill label sample refers to the splicing of features in individual dimensions. For example, if the number of dimensions of the semantic representation vector of the skill label sample is 128, and the number of dimensions of the semantic representation vector of the context of the skill label sample is 128, then the number of dimensions of the feature vector after feature splicing is 258.

It is noted that since the semantic representation vector of the skill label sample and the semantic representation vector of the context of the skill label sample may have high dimensions, the semantic representation vector of the skill label sample and the semantic representation vector of the context of the skill label sample may be first subjected to feature transformation through full connection layers, respectively, and the feature vector obtained by the feature transformation may be subjected to feature splicing.

In step 1007, the transformed feature vector is obtained by inputting the spliced feature vector into the multi-layer full connection layer to perform feature transformation on the spliced feature vector.

In step 1008, a classification probability of the skill label sample is obtained by performing classification on the transformed feature vector based on the classification layer.

In step 1009, the candidate phrase classification model is trained according to the classification probability of the skill label sample.

It is noted that in the process of training the candidate phrase classification model shown in FIG. 5, the implementation process of step 805 in FIG. 8 may only include steps 1003 to 1009. That is, there is no need to perform word segmentation and obtain the multi-dimensional feature vector again.

It is noted that in the process of training the candidate phrase classification model shown in FIG. 5, the above-mentioned steps 1001 to 1008 may also be used in step 803 in FIG. 8, which will not be repeated here.

According to the method for training the candidate phrase classification model in embodiments of the present disclosure, a second semantic representation layer is added to the structure of the model to generate the semantic representation vector of the context of the skill label sample by using the multi-dimensional feature vector of each word in the context of the skill label sample, so that the obtained features of the skill label sample are more comprehensive, thus improving the training effect of the candidate phrase classification model, and improving the portability of the candidate phrase classification model.

In order to further improve the training effect of the model, the present disclosure also provides an embodiment as follows.

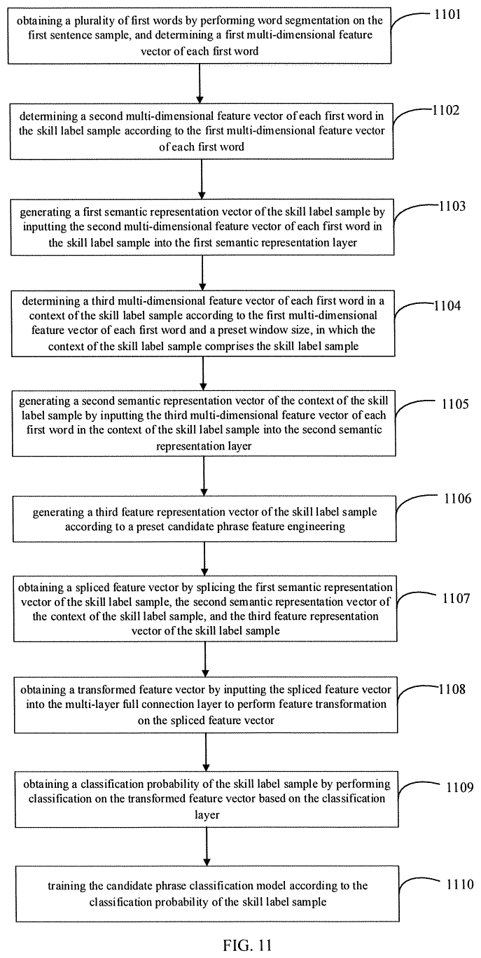

FIG. 11 is a flowchart illustrating a method for training a candidate phrase classification model according to an embodiment of the present disclosure. In embodiments of the disclosure, the candidate phrase classification model includes a first semantic representation layer, a second semantic representation layer, a classification layer, and a multi-layer full connection layer, which has a structure consistent with that of the model shown in FIG. 5. Based on the above-mentioned embodiment, in step 802 in FIG. 8, the implementation process of obtaining the trained candidate phrase classification model by training the candidate phrase classification model according to the first sentence sample and the skill label sample corresponding to the first sentence sample may include step 1001 to step 1009 as shown in FIG. 11.

In step 1101, a plurality of first words are obtained by performing word segmentation on the first sentence sample, and a first multi-dimensional feature vector of each first word is determined.

In step 1102, a second multi-dimensional feature vector of each first word in the skill label sample is determined according to the first multi-dimensional feature vector of each first word.

In step 1103, a first semantic representation vector of the skill label sample is generated by inputting the second multi-dimensional feature vector of each first word in the skill label sample into the first semantic representation layer.

In step 1104, a third multi-dimensional feature vector of each first word in a context of the skill label sample is determined according to the first multi-dimensional feature vector of each first word and a preset window size. The context of the skill label sample includes the skill label sample.

In step 1105, a second semantic representation vector of the context of the skill label sample is generated by inputting the third multi-dimensional feature vector of each first word in the context of the skill label sample into the second semantic representation layer.

In step 1106, a third feature representation vector of the skill label sample is generated according to a preset candidate phrase feature engineering.

In some embodiments of the present disclosure, the candidate phrase feature engineering is configured to extract other features of the candidate phrase from original data to improve the accuracy of training the model. As an example, the candidate phrase feature engineering may include features, such as the number of words in the candidate phrase, the position of the candidate phrase in the sentence to be extracted, and whether the candidate phrase is composed of English words.

In some embodiments, information of each feature in the candidate phrase feature engineering corresponding to the skill label sample may be determined according to the candidate phrase feature engineering, so as to generate other feature representation vectors of the skill label sample based on the expression of information of the feature.

In step 1107, a spliced feature vector is obtained by splicing the first semantic representation vector of the skill label sample, the second semantic representation vector of the context of the skill label sample, and the third feature representation vector of the skill label sample.

It is noted that, since the semantic representation vector of the skill label sample, the semantic representation vector of the context of the skill label sample, and other representation vectors of the skill label sample may have high dimensions, the semantic representation vector of the skill label sample, the semantic representation vector of the context of the skill label sample, and other representation vectors of the skill label sample may be first subjected to feature transformation through full connection layers, respectively, and the feature vectors obtained by feature transformation are subjected to feature splicing. As an example, the structure of the candidate phrase classification model in embodiments of the present disclosure may also be as shown in FIG. 10, that is, the outputs of the first semantic representation layer and the second semantic representation layer may be subjected to feature transformation through full connection layers, respectively, while other feature representation vectors may also be subjected to feature transformation through a full connection layer first, and then the transformed features may be spliced and input to the multi-layer full connection layer.

In step 1108, the transformed feature vector is obtained by inputting the spliced feature vector into the multi-layer full connection layer to perform feature transformation on the spliced feature vector.

In step 1109, a classification probability of the skill label sample is obtained by performing classification on the transformed feature vector based on the classification layer.

In step 1110, the candidate phrase classification model is trained according to the classification probability of the skill label sample.

It is noted that in the process of training the candidate phrase classification model according to embodiments of the present disclosure, the implementation process of step 805 in FIG. 8 may only include steps 1103 to 1110, that is, there is no need to perform word segmentation and obtain the multi-dimensional feature vector again.

It is noted that the above-mentioned steps 1101 to 1109 may also be used in step 803 in FIG. 8 in the process of training the candidate phrase classification model according to embodiments of the present disclosure, which will not be repeated here.

According to the method for training the candidate phrase classification model in embodiments of the present disclosure, through the preset candidate phrase feature engineering, other feature representation vectors of the skill label sample may be generated to enrich the resulting spliced features, which may further improve the training effect of the model and make the trained candidate phrase classification model more accurate.

In order to implement the above-mentioned embodiments, the present disclosure also provides an apparatus for extracting a skill label.

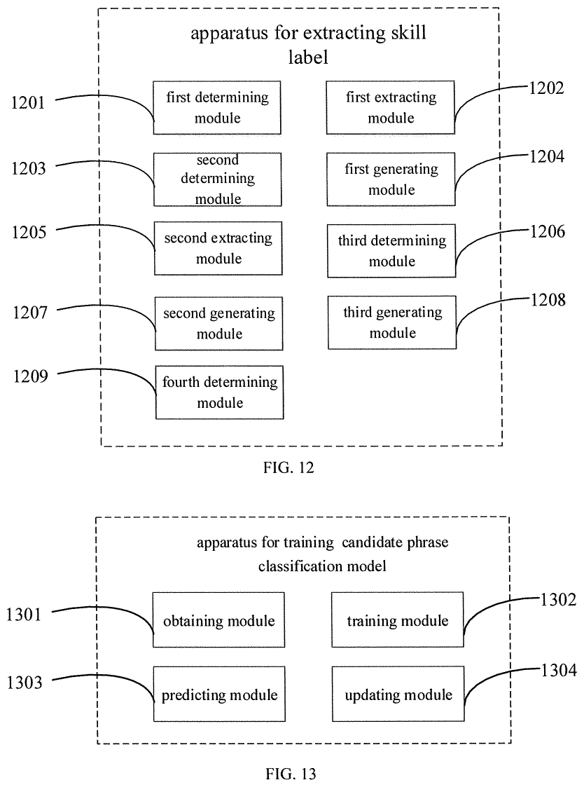

FIG. 12 is a block diagram illustrating an apparatus for extracting a skill label according to an embodiment of the present disclosure. As shown in FIG. 12, the apparatus includes a first determining module 1201, a first extracting module 1202, a second determining module 1203, a first generating module 1204 and a second extracting module 1205.

The first determining module 1201 is configured to obtain a plurality of words by performing word segmentation on a sentence to be extracted, and determine a first multi-dimensional feature vector of each word.

The first extracting module 1202 is configured to extract a candidate phrase from the sentence to be extracted.

The second determining module 1203 is configured to determine a second multi-dimensional feature vector of each word in the candidate phrase according to the first multi-dimensional feature vector of each word.

The first generating module 1204 is configured to generate a first semantic representation vector of the candidate phrase according to the second multi-dimensional feature vector of each word in the candidate phrase.

The second extracting module 1205 is configured to extract the skill label from the sentence to be extracted based on the first semantic representation vector of the candidate phrase.

In some embodiments, the first extracting module 1202 is configured to obtain a part-of-speech label of each word from the first multi-dimensional feature vector of each word; and extract the candidate phrase from the sentence to be extracted based on a preset candidate phrase template and the part-of-speech label of each word.

In some embodiments, the second determining module 1203 is configured to determine at least one target word comprised in the candidate phrase; and determine a target multi-dimensional feature vector of each target word according to the first multi-dimensional feature vector of each word.

In some embodiments, the second extracting module 1205 is configured to obtain a classification probability of the candidate phrase based on the first semantic representation vector of the candidate phrase; and determine the candidate phrase as the skill label in response to the classification probability being greater than a preset threshold.

In some embodiments, the apparatus further includes a third determining module 1206 and a second generating module 1207.

The third determining module 1206 is configured to determine a third multi-dimensional feature vector of each word in a context of the candidate phrase according to the first multi-dimensional feature vector of each word and a preset window size. The context of the candidate phrase includes the candidate phrase.

The second generating module 1207 is configured to generate a second semantic representation vector of the context of the candidate phrase according to the third multi-dimensional feature vector of each word in the context of the candidate phrase.

The second extracting module 1205 is further configured to extract the skill label from the sentence to be extracted based on the first semantic representation vector of the candidate phrase and the second semantic representation vector of the context of the candidate phrase.

In some embodiments, the apparatus further includes a third generating module 1208 configured to generate a third feature representation vector of the candidate phrase according to a preset candidate phrase feature engineering.

The second extracting module 1205 is further configured to extract the skill label from the sentences to be extracted based on the first semantic representation vector of the candidate phrase, the second semantic representation vector of the context of the candidate phrase, and the third feature representation vector of the candidate phrase.

In some embodiments, the apparatus is implemented based on a preset candidate phrase classification model. The candidate phrase classification model includes a first semantic representation layer, a second semantic representation layer, a classification layer and a multi-layer full connection layer.

The first generating module 1205 is configured to generate the first semantic representation vector of the candidate phrase by inputting the second multi-dimensional feature vector of each word in the candidate phrase into the first semantic representation layer.

The second generating module 1207 is configured to generate the second semantic representation vector of the context of the candidate phrases by inputting the third multi-dimensional feature vector of each word in the context of the candidate phrase into the second semantic representation layer.

The second extracting module 1205 is configured to obtain a spliced feature vector by splicing the first semantic representation vector of the candidate phrase, the second semantic representation vector of the context of the candidate phrase and the third feature representation vector of the candidate phrase; obtain a transformed feature vector by inputting the spliced feature vector into the multi-layer full connection layer to perform feature transformation on the spliced feature vector; obtain a classification probability of the candidate phrase by inputting the transformed feature vector into the classification layer to perform classification based on the transformed feature vector; and determine the candidate phrase as the skill label in response to the classification probability being greater than a preset threshold.

In some embodiments, the apparatus further includes a fourth determining module 1209 configured to determine a classification of the skill label after extracting the skill label from the sentence to be extracted.

According to the apparatus for extracting the skill label in embodiments of the present disclosure, the candidate phrase is extracted from the sentence to be extracted, the semantic representation vector of the candidate phrase is generated according to the multi-dimensional feature vector of each word in the candidate phrase, and the skill label is extracted from the sentence to be extracted based on the semantic representation vector of the candidate phrase, which realizes automatic extraction of the skill label. The multi-dimensional feature vector of each word in the candidate phrase is used to extract the skill label, which may effectively improve the accuracy of the extraction of the skill label, and provide useful conditions for enterprises to realize intelligent personnel manage.

In order to implement the above-mentioned embodiments, the present disclosure provides an apparatus for training a candidate phrase classification model.

FIG. 13 is a block diagram illustrating an apparatus for training a candidate phrase classification model according to an embodiment of the present disclosure. As shown in FIG. 13, the apparatus may include an obtaining module 1301, a training module 1302, a predicting module 1303 and an updating module 1304.

The obtaining module 1301 is configured to obtain a labeled training set and an unlabeled data set. The labeled training set includes a first sentence sample and a skill label sample corresponding to the first sentence sample, and the unlabeled data set includes second sentence samples and candidate phrase samples corresponding to the second sentence samples.

The training module 1302 is configured to obtain a trained candidate phrase classification model by training the candidate phrase classification model according to the first sentence sample and the skill label sample corresponding to the first sentence sample.

The predicting module 1303 is configured to predict a classification probability of each candidate phrase sample in the unlabeled data set based on the trained candidate phrase classification model.

The updating module 1304 is configured to update the labeled training set and the unlabeled data set based on the classification probability.

The training module 1302 is further configured to train the trained candidate phrase classification model based on the labeled training set updated.

In some embodiments, the updating module 1304 is configured to obtain a target candidate phrase sample with a classification probability greater than a probability threshold from the candidate phrase samples; add the target candidate phrase sample and a second sentence sample corresponding the target candidate phrase sample into the labeled training set, wherein the target candidate phrase sample is a skill label sample of the second sentence sample corresponding to the target candidate phrase sample; and delete the target candidate phrase sample and the second sentence sample corresponding to the target candidate phrase sample in the unlabeled data set.

In some embodiments, the candidate phrase classification model includes a first semantic representation layer, a classification layer and a multi-layer full connection layer.

The training module 1302 is configured to obtain a plurality of first words by performing word segmentation on the first sentence sample, and determining a first multi-dimensional feature vector of each first word; determine a second multi-dimensional feature vector of each first word in the skill label sample according to the first multi-dimensional feature vector of each first word; generate a first semantic representation vector of the skill label sample by inputting the second multi-dimensional feature vector of each first word in the skill label sample into the first semantic representation layer; obtain a transformed feature vector by performing feature transformation on the first semantic representation vector of the skill label sample based on the multi-layer full connection layer; obtain a classification probability of the skill label sample by performing classification on the transformed feature vector based on the classification layer; and train the candidate phrase classification model according to the classification probability of the skill label sample.

In some embodiments, the training module 1302 is configured to obtain a real classification value of the skill label sample; obtain a loss value according to the real classification value of the skill label sample and the classification probability of the skill label sample; and train the candidate phrase classification model according to the loss value.

In some embodiments, the candidate phrase classification model further includes a second semantic representation layer.

The training module 1302 is further configured to determine a third multi-dimensional feature vector of each first word in a context of the skill label sample according to the first multi-dimensional feature vector of each first word and a preset window size, in which the context of the skill label sample includes the skill label sample; generate a second semantic representation vector of the context of the skill label sample by inputting the third multi-dimensional feature vector of each first word in the context of the skill label sample into the second semantic representation layer; obtain a spliced feature vector by splicing the first semantic representation vector of the skill label sample and the second semantic representation vector of the context of the skill label sample; and obtain the transformed feature vector by inputting the spliced feature vector into the multi-layer full connection layer to perform feature transformation on the spliced feature vector.

In some embodiments, the training module 1302 is further configured to generate a third feature representation vector of the skill label sample according to a preset candidate phrase feature engineering; and obtain the spliced feature vector by splicing the first semantic representation vector of the skill label sample, the second semantic representation vector of the context of the skill label sample, and the third feature representation vector of the skill label sample.

According to the apparatus for training the candidate phrase classification model in embodiments of the disclosure, the candidate phrase classification model is trained based on the labeled training set, and the labeled training set and the unlabeled data set are continuously updated based on the prediction result of the classification probability of the candidate phrase sample in the unlabeled data set with the trained candidate phrase classification model, so as to train the candidate phrase classification model circularly. That is, only a small amount of labeled data may be used to train the model, which may not only improve the training effect of the model based on self-training, but also reduce the cost of training data.

According to embodiments of the present disclosure, the present disclosure also provides an electronic device, a readable storage medium and a computer program product.

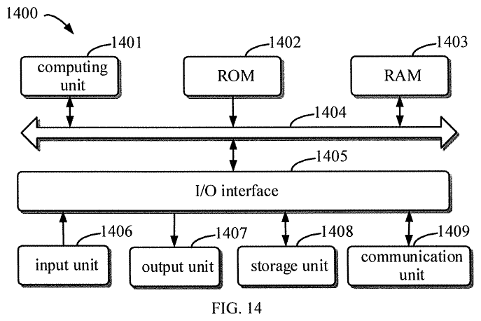

FIG. 14 is a block diagram of an electronic device 1400 configured to perform the method in some embodiments of the present disclosure. The electronic device is intended to represent various forms of digital computers, such as laptops, desktops, workbenches, personal digital assistants, servers, blade servers, mainframe computers and other suitable computing devices. The electronic device may further represent various forms of mobile devices, such as personal digital assistants, cellular phones, smart phones, wearable devices and other similar computing devices. The components, their connections and relationships, and their functions shown herein are examples only, and are not intended to limit the implementation of the present disclosure as described and/or required herein.

As shown in FIG. 14, the electronic device 1400 may include a computing unit 1401, which may perform various suitable actions and processing according to a computer program stored in a read-only memory (ROM) 1402 or a computer program loaded from a storage unit 1408 into a random access memory (RAM) 1403. The RAM 1403 may also store various programs and data required to operate the electronic device 1400. The computing unit 1401, the ROM 1402 and the RAM 1403 are connected to one another via a bus 1404. An input/output (I/O) interface 1405 is also connected to the bus 1404.

A plurality of components in the electronic device 1400 are connected to the I/O interface 1405, including an input unit 1406, such as a keyboard and a mouse; an output unit 1407, such as various displays and speakers; a storage unit 1408, such as magnetic disks and optical discs; and a communication unit 1409, such as a network card, a modem and a wireless communication transceiver. The communication unit 1409 allows the electronic device 1400 to exchange information/data with other devices over computer networks such as the Internet and/or various telecommunications networks.

The computing unit 1401 may be a variety of general-purpose and/or special-purpose processing components with processing and computing capabilities. Some examples of the computing unit 1401 include, but are not limited to, a central processing unit (CPU), a graphics processing unit (GPU), various dedicated artificial intelligence (AI) computing chips, various computing units that run machine learning model algorithms, a digital signal processor (DSP), any appropriate processor, controller or microcontroller, etc. The computing unit 1401 is configured to perform the methods and processing described above, such as the method for extracting the skill label, and/or the method for training the candidate phrase classification model. For example, in some embodiments, the method for extracting the skill label, and/or the method for training the candidate phrase classification model may be implemented as a computer software program that is tangibly embodied in a machine-readable medium, such as the storage unit 1408. In some embodiments, part or all of a computer program may be loaded and/or installed on the electronic device 1400 via the ROM 1402 and/or the communication unit 1409. One or more steps of the method for extracting the skill label, and/or the method for training the candidate phrase classification model described above may be performed when the computer program is loaded into the RAM 1403 and executed by the computing unit 1401. Alternatively, in other embodiments, the computing unit 1401 may be configured to perform the method for extracting the skill label, and/or the method for training the candidate phrase classification model by any other appropriate means (for example, by means of firmware).

Various implementations of the systems and technologies disclosed herein may be realized in a digital electronic circuit system, an integrated circuit system, a field programmable gate array (FPGA), an application-specific integrated circuit (ASIC), an application-specific standard product (ASSP), a system on chip (SOC), a complex programmable logic device (CPLD), computer hardware, firmware, software, and/or combinations thereof. Such implementations may include implementation in one or more computer programs that are executable and/or interpretable on a programmable system including at least one programmable processor. The programmable processor can be special or general purpose, and configured to receive data and instructions from a storage system, at least one input apparatus, and at least one output apparatus, and to transmit data and instructions to the storage system, the at least one input apparatus, and the at least one output apparatus.

Program codes configured to implement the methods in the present disclosure may be written in one or any combination of multiple programming languages. Such program codes may be supplied to a processor or controller of a general-purpose computer, a special-purpose computer, or another programmable data processing apparatus to enable the function/operation specified in the flowchart and/or block diagram to be implemented when the program codes are executed by the processor or controller. The program codes may be executed entirely on a machine, partially on a machine, partially on a machine and partially on a remote machine as a stand-alone software package, or entirely on a remote machine or a server.

In the context of the present disclosure, machine-readable media may be tangible media which may include or store programs for use by or in conjunction with an instruction execution system, apparatus or device. The machine-readable media may be machine-readable signal media or machine-readable storage media. The machine-readable media may include, but are not limited to, electronic, magnetic, optical, electromagnetic, infrared, or semiconductor systems, apparatuses or devices, or any suitable combination thereof. More specific examples of machine-readable storage media may include electrical connections based on one or more wires, a portable computer disk, a hard disk, a random access memory (RAM), a read-only memory (ROM), an erasable programmable read only memory (EPROM or flash memory), an optical fiber, a compact disk read only memory (CD-ROM), an optical storage device, a magnetic storage device, or any suitable combination thereof.

To provide interaction with a user, the systems and technologies described here can be implemented on a computer. The computer has: a display apparatus (e.g., a cathode-ray tube (CRT) or a liquid crystal display (LCD) monitor) for displaying information to the user; and a keyboard and a pointing apparatus (e.g., a mouse or trackball) through which the user may provide input for the computer. Other kinds of apparatuses may also be configured to provide interaction with the user. For example, a feedback provided for the user may be any form of sensory feedback (e.g., visual, auditory, or tactile feedback); and input from the user may be received in any form (including sound input, speech input, or tactile input).

The systems and technologies described herein can be implemented in a computing system including background components (e.g., as a data server), or a computing system including middleware components (e.g., an application server), or a computing system including front-end components (e.g., a user computer with a graphical user interface or web browser through which the user can interact with the implementations of the systems and technologies described here), or a computing system including any combination of such background components, middleware components or front-end components. The components of the system can be connected to each other through any form or medium of digital data communication (e.g., a communication network). Examples of the communication network include: a local area network (LAN), a wide area network (WAN), the Internet and a block chain network.

The computer device may include a client and a server. The client and the server are generally far away from each other and generally interact with each other via the communication network. A relationship between the client and the server is generated through computer programs that run on a corresponding computer and have a client-server relationship with each other. The server may be a cloud server, a distributed system server, or a server combined with a block chain.

It is understood that the steps can be reordered, added, or deleted using the various forms of processes shown above. For example, the steps described in the present application may be executed in parallel or sequentially or in different sequences, provided that desired results of the technical solutions disclosed in the present disclosure are achieved, which is not limited herein.

The above-mentioned embodiments are not intended to limit the extent of protection of the present disclosure. Those skilled in the art should understand that various modifications, combinations, sub-combinations, and replacements can be made according to design requirements and other factors. Any modifications, equivalent substitutions and improvements made within the spirit and principle of the present disclosure should be included in the extent of protection of the present disclosure.

What is claimed is:

1. A method for extracting a skill label, comprising:
obtaining a plurality of words by performing word segmentation on a sentence to be extracted, and determining a first multi-dimensional feature vector of each word;
extracting a candidate phrase from the sentence to be extracted;
determining a second multi-dimensional feature vector of each word in the candidate phrase according to the first multi-dimensional feature vector of each word;
generating a first semantic representation vector of the candidate phrase according to the second multi-dimensional feature vector of each word in the candidate phrase;
extracting the skill label from the sentence to be extracted based on the first semantic representation vector of the candidate phrase.

2. The method according to claim 1, wherein extracting the candidate phrase from the sentence to be extracted comprises:
obtaining a part-of-speech label of each word from the first multi-dimensional feature vector of each word;
extracting the candidate phrase from the sentence to be extracted based on a preset candidate phrase template and the part-of-speech label of each word.

3. The method according to claim 1, wherein determining the second multi-dimensional feature vector of each word in the candidate phrase according to the first multi-dimensional feature vector of each word comprises:
determining at least one target word comprised in the candidate phrase;
determining a target multi-dimensional feature vector of each target word according to the first multi-dimensional feature vector of each word.

4. The method according to claim 1, wherein extracting the skill label from the sentence to be extracted based on the first semantic representation vector of the candidate phrases comprises:
obtaining a classification probability of the candidate phrase based on the first semantic representation vector of the candidate phrase;
determining the candidate phrase as the skill label in response to the classification probability being greater than a preset threshold.

5. The method according to claim 1, further comprising:
determining a third multi-dimensional feature vector of each word in a context of the candidate phrase according to the first multi-dimensional feature vector of each word and a preset window size, wherein the context of the candidate phrase comprises the candidate phrase;
generating a second semantic representation vector of the context of the candidate phrase according to the third multi-dimensional feature vector of each word in the context of the candidate phrase;
wherein extracting the skill label from the sentence to be extracted based on the first semantic representation vector of the candidate phrase comprises:
extracting the skill label from the sentence to be extracted based on the first semantic representation vector of the candidate phrase and the second semantic representation vector of the context of the candidate phrase.

6. The method according to claim 5, further comprising:
generating a third feature representation vector of the candidate phrase according to a preset candidate phrase feature engineering;
wherein extracting the skill label from the sentence to be extracted based on the first semantic representation vector of the candidate phrase and the second semantic representation vector of the context of the candidate phrase comprises:
extracting the skill label from the sentence to be extracted based on the first semantic representation vector of the candidate phrase, the second semantic representation vector of the context of the candidate phrase, and the third feature representation vector of the candidate phrase.

7. The method according to claim 6, implemented based on a preset candidate phrase classification model;
wherein the candidate phrase classification model comprises a first semantic representation layer, a second semantic representation layer, a classification layer and a multi-layer full connection layer;
wherein generating the first semantic representation vector of the candidate phrase according to the second multi-dimensional feature vector of each word in the candidate phrase comprises:
generating the first semantic representation vector of the candidate phrase by inputting the second multi-dimensional feature vector of each word in the candidate phrase into the first semantic representation layer;
wherein generating the second semantic representation vector of the context of the candidate phrase according to the third multi-dimensional feature vector of each word in the context of the candidate phrase comprises:
generating the second semantic representation vector of the context of the candidate phrases by inputting the third multi-dimensional feature vector of each word in the context of the candidate phrase into the second semantic representation layer;
wherein extracting the skill label from the sentence to be extracted based on the first semantic representation vector of the candidate phrase, the second semantic representation vector of the context of the candidate phrase, and the third feature representation vector of the candidate phrase comprises:
obtaining a spliced feature vector by splicing the first semantic representation vector of the candidate phrase, the second semantic representation vector of the context of the candidate phrase and the third feature representation vector of the candidate phrase;
obtaining a transformed feature vector by inputting the spliced feature vector into the multi-layer full connection layer to perform feature transformation on the spliced feature vector;
obtaining a classification probability of the candidate phrase by inputting the transformed feature vector into the classification layer to perform classification based on the transformed feature vector;
determining the candidate phrase as the skill label in response to the classification probability being greater than a preset threshold.

8. The method according to claim 1, after extracting the skill label from the sentence to be extracted, further comprising:
determining a classification of the skill label.

9. A method for training a candidate phrase classification model, comprising:
obtaining a labeled training set and an unlabeled data set, wherein the labeled training set comprises a first sentence sample and a skill label sample corresponding to the first sentence sample, and the unlabeled data set comprises second sentence samples and candidate phrase samples corresponding to the second sentence samples;
obtaining a trained candidate phrase classification model by training the candidate phrase classification model according to the first sentence sample and the skill label sample corresponding to the first sentence sample;
predicting a classification probability of each candidate phrase sample in the unlabeled data set based on the trained candidate phrase classification model;
updating the labeled training set and the unlabeled data set based on the classification probability; and
training the trained candidate phrase classification model based on the labeled training set updated.

10. The method according to claim 9, wherein updating the labeled training set and the unlabeled data set based on the classification probability comprises:
obtaining a target candidate phrase sample with a classification probability greater than a probability threshold from the candidate phrase samples;
adding the target candidate phrase sample and a second sentence sample corresponding the target candidate phrase sample into the labeled training set, wherein the target candidate phrase sample is a skill label sample of the second sentence sample corresponding to the target candidate phrase sample;
deleting the target candidate phrase sample and the second sentence sample corresponding to the target candidate phrase sample in the unlabeled data set.

11. The method according to claim 9, wherein the candidate phrase classification model comprises a first semantic representation layer, a classification layer and a multi-layer full connection layer;
obtaining the trained candidate phrase classification model by training the candidate phrase classification model according to the first sentence sample and the skill label sample corresponding to the first sentence sample comprises:
obtaining a plurality of first words by performing word segmentation on the first sentence sample, and determining a first multi-dimensional feature vector of each first word;
determining a second multi-dimensional feature vector of each first word in the skill label sample according to the first multi-dimensional feature vector of each first word;
generating a first semantic representation vector of the skill label sample by inputting the second multi-dimensional feature vector of each first word in the skill label sample into the first semantic representation layer;
obtaining a transformed feature vector by performing feature transformation on the first semantic representation vector of the skill label sample based on the multi-layer full connection layer;
obtaining a classification probability of the skill label sample by performing classification on the transformed feature vector based on the classification layer;
training the candidate phrase classification model according to the classification probability of the skill label sample.

12. The method according to claim 11, wherein training the candidate phrase classification model according to the classification probability of the skill label sample comprises:
obtaining a real classification value of the skill label sample;
obtaining a loss value according to the real classification value of the skill label sample and the classification probability of the skill label sample;
training the candidate phrase classification model according to the loss value.

13. The method according to claim 11, wherein the candidate phrase classification model further comprises a second semantic representation layer;
obtaining the trained candidate phrase classification model by training the candidate phrase classification model according to the first sentence sample and the skill label sample corresponding to the first sentence sample further comprises:
determining a third multi-dimensional feature vector of each first word in a context of the skill label sample according to the first multi-dimensional feature vector of each first word and a preset window size, wherein the context of the skill label sample comprises the skill label sample;
generating a second semantic representation vector of the context of the skill label sample by inputting the third multi-dimensional feature vector of each first word in the context of the skill label sample into the second semantic representation layer;
wherein obtaining the transformed feature vector by performing feature transformation on the first semantic representation vector of the skill label sample based on the multi-layer full connection layer comprises:
obtaining a spliced feature vector by splicing the first semantic representation vector of the skill label sample and the second semantic representation vector of the context of the skill label sample;
obtaining the transformed feature vector by inputting the spliced feature vector into the multi-layer full connection layer to perform feature transformation on the spliced feature vector.

14. The method according to claim 13, wherein obtaining the trained candidate phrase classification model by training the candidate phrase classification model according to the first sentence sample and the skill label sample corresponding to the first sentence sample further comprises:
generating a third feature representation vector of the skill label sample according to a preset candidate phrase feature engineering;
wherein obtaining the spliced feature vector by splicing the first semantic representation vector of the skill label sample and the second semantic representation vector of the context of the skill label sample comprises:
obtaining the spliced feature vector by splicing the first semantic representation vector of the skill label sample, the second semantic representation vector of the context of the skill label sample, and the third feature representation vector of the skill label sample.

15. An electronic device, comprising:
at least one processor; and
a memory communicatively connected to the at least one processor for storing instructions executable by the at least one processor;
wherein the at least one processor is configured to:
obtain a plurality of words by performing word segmentation on a sentence to be extracted, and determining a first multi-dimensional feature vector of each word;
extract a candidate phrase from the sentence to be extracted;
determine a second multi-dimensional feature vector of each word in the candidate phrase according to the first multi-dimensional feature vector of each word;
generate a first semantic representation vector of the candidate phrase according to the second multi-dimensional feature vector of each word in the candidate phrase;
extract the skill label from the sentence to be extracted based on the first semantic representation vector of the candidate phrase.

16. The electronic device according to claim 15, wherein the at least one processor is configured to:
obtain a part-of-speech label of each word from the first multi-dimensional feature vector of each word;
extract the candidate phrase from the sentence to be extracted based on a preset candidate phrase template and the part-of-speech label of each word.

17. The electronic device according to claim 15, wherein the at least one processor is configured to:
determine at least one target word comprised in the candidate phrase;
determine a target multi-dimensional feature vector of each target word according to the first multi-dimensional feature vector of each word.

18. The electronic device according to claim 15, wherein the at least one processor is configured to:
obtain a classification probability of the candidate phrase based on the first semantic representation vector of the candidate phrase;
determine the candidate phrase as the skill label in response to the classification probability being greater than a preset threshold.

19. The electronic device according to claim 15, wherein the at least one processor is further configured to:
determine a third multi-dimensional feature vector of each word in a context of the candidate phrase according to the first multi-dimensional feature vector of each word and a preset window size, wherein the context of the candidate phrase comprises the candidate phrase;
generate a second semantic representation vector of the context of the candidate phrase according to the third multi-dimensional feature vector of each word in the context of the candidate phrase.

20. The electronic device according to claim 19, wherein the at least one processor is further configured to:
generate a third feature representation vector of the candidate phrase according to a preset candidate phrase feature engineering.
